(19) United States
(12) Patent Application Publication
(10) Pub. No.: US 2020/0262132 A1
(43) Pub. Date: Aug. 20, 2020

(54) SHAPING METHOD AND SHAPING DEVICE

(71) Applicant: MIMAKI ENGINEERING CO., LTD., Nagano (JP)

(72) Inventor: Takeaki Kazaana, Nagano (JP)

(73) Assignee: MIMAKI ENGINEERING CO., LTD., Nagano (JP)

(21) Appl. No.: 16/782,067

(22) Filed: Feb. 5, 2020

(30) Foreign Application Priority Data
Feb. 15, 2019 (JP) 2019-025752

(51) Int. Cl. B29C 64/10

(52) U.S. Cl. CPC B29C 64/10; B33Y 80/00

(57) ABSTRACT

The shaping method of the present embodiment is a shaping method for a shaped object configured to include at least a color layer that is colored and that forms the surface of the shaped object, and a reflection layer that forms the lower layer of the color layer, and determines the thickness of the reflection layer with a normal direction with respect to an outer contour of the shaped object as a reference. According to the present configuration, the thickness of the reflection layer is set to a thickness enough to reflect the color of the color layer so that an interior layer can be prevented from affecting the color of the shaped object visually recognized from the outside even if an interior layer formed under the reflection layer is formed of an arbitrary color or material.

### CROSS REFERENCE TO RELATED APPLICATIONS

This application claims the priority benefit of Japanese Patent Application No. 2019-025752, filed on Feb. 15, 2019. The entirety of the above-mentioned patent application is hereby incorporated by reference herein and made a part of this specification.

### TECHNICAL FIELD

The present disclosure relates to a shaping method and a shaping device.

### DESCRIPTION OF THE BACKGROUND ART

In recent years, use of a shaping device (3D printer) that ejects ink to shape a three-dimensional object is being advanced. Such a shaping device performs shaping through a layered shaping method in which a plurality of ink layers is overlapped.

Here, a large shaped object requires a large amount of material such as ink to use for shaping. Therefore, Japanese Unexamined Patent Publication No. 2007-71154 (i.e., Patent Literature 1) discloses a method of shaping a shaped object interiorly including a cavity. Thus, the material used for shaping can be reduced, and the weight of the shaped object can be reduced. Furthermore, the customizability of the shaped object can be enhanced, and the material can be effectively used by forming the interior layer of the shaped object with a material of an arbitrary color.

Patent Literature 1: Japanese Unexamined Patent Publication No. 2007-71154

### SUMMARY

However, if the thickness of the lower layer of the colored layer that forms the surface of the shaped object is not an appropriate thickness, the color of the interior layer and the hollowing of the interior layer may affect the color of the shaped object visually recognized from the outside.

The present disclosure thus provides a shaping method and a shaping device that prevent an interior layer from affecting the color of the shaped object visually recognized from the outside.

A shaping method of the present disclosure relates to a shaping method including: forming a shaped object configured to include at least a colored layer that is colored and that forms a surface of the shaped object and a reflection layer that forms a lower layer of the colored layer, in which a thickness of the reflection layer is determined with a normal direction with respect to an outer contour of the shaped object as a reference. According to the present configuration, in order to reflect the color of the colored layer, the thickness of the reflection layer is set to a sufficient thickness having the normal direction with respect to the outer contour of the shaped object as a reference. Thus, even if the interior layer formed under the reflection layer is formed of an arbitrary color or material, the interior layer can be prevented from affecting the color of the shaped object visually recognized from the outside.

In the shaping method of the present disclosure, when the lower layer of the colored layer is a cavity, a combined thickness of the colored layer and the reflection layer may be a thickness for maintaining a mechanical strength of the shaped object. According to the present configuration, the amount of material for forming the shaped object can be reduced while maintaining the shape of the shaped object.

In the shaping method of the present disclosure, when the lower layer of the colored layer is a cavity, a reinforcement layer may be formed between the reflection layer and the cavity, and a combined thickness of the colored layer, the reflection layer, and the reinforcement layer may be a thickness for maintaining a mechanical strength of the shaped object. According to the present configuration, the amount of material for forming the shaped object can be reduced while maintaining the shape of the shaped object.

In the shaping method of the present disclosure, a color of the reinforcement layer may be specified. According to the present configuration, the material for forming the shaped object can be used effectively.

In the shaping method of the present disclosure, the thickness of the reflection layer may be determined according to a built-in element built in the lower layer of the reflection layer. For example, when a light emitting body is the built-in element, it is desirable that the light emission from the light emitting body can be visually recognized from the outside of the shaped object. According to the present configuration, the shaped object utilizing the action of the built-in element can be formed.

In the shaping method of the present disclosure, a thickness data indicating the thicknesses of the colored layer and the reflection layer with the normal direction with respect to the outer contour of the shaped object as a reference may be generated. According to the present configuration, the thicknesses of the colored layer and the reflection layer can be made to an appropriate thickness.

In the shaping method of the present disclosure, the colored layer may be formed on an outer side with the outer contour of the shaped object as a reference. According to the present configuration, the colored layer can be formed at a position suitable for the shaped object.

In the shaping method of the present disclosure, the colored layer may be formed on an inner side with the outer contour of the shaped object as a reference. According to the present configuration, the colored layer can be formed at a position suitable for the shaped object.

A shaping device of the present disclosure relates to a shaping device for a shaped object configured to include at least a colored layer that is colored and that forms a surface of the shaped object and a reflection layer that forms a lower layer of the colored layer, in which the reflection layer having a thickness determined based on a normal direction with respect to an outer contour of the shaped object is layered on the lower layer of the colored layer. According to the present configuration, the interior layer can be prevented from affecting the color of the shaped object visually recognized from the outside.

The present disclosure can prevent the interior layer from affecting the color of the shaped object visually recognized from the outside.

### BRIEF DESCRIPTION OF THE DRAWINGS

FIG. 1 is a schematic view showing a configuration of a 3D printer system according to a first embodiment.

FIG. 2 is a schematic view showing a layered structure of a shaped object according to the first embodiment.

FIG. 3 is a layout image of a shaped object and a selection image of a color of an interior layer according to the first embodiment.

FIGS. 4A and 4B are schematic diagrams showing a cross-section of a shaped object corresponding to the color of the interior layer according to the first embodiment.

FIGS. 5A to 5C are schematic diagrams showing a shaping method when the interior layer is a cavity according to the first embodiment.

FIG. 6 is a functional block diagram relating to an internal structure changing process of the shaped object according to the first embodiment.

FIG. 7 is a flowchart showing a flow of shaping operation process according to the first embodiment.

FIG. 8 is a flowchart showing a flow of shaping process according to the first embodiment.

FIGS. 9A to 9C are schematic diagrams relating to setting of an outer contour reinforcement layer when an interior layer is a cavity according to a second embodiment.

FIG. 10 is a flowchart showing a flow of slice data generation process according to the second embodiment.

FIG. 11 is a schematic view showing a cross-section of a shaped object in which a light emitting body is built in according to a third embodiment.

### DETAILED DESCRIPTION OF EMBODIMENTS

Hereinafter, a shaping method and a shaping device according to an embodiment of the present disclosure will be described with reference to the drawings.

### First Embodiment

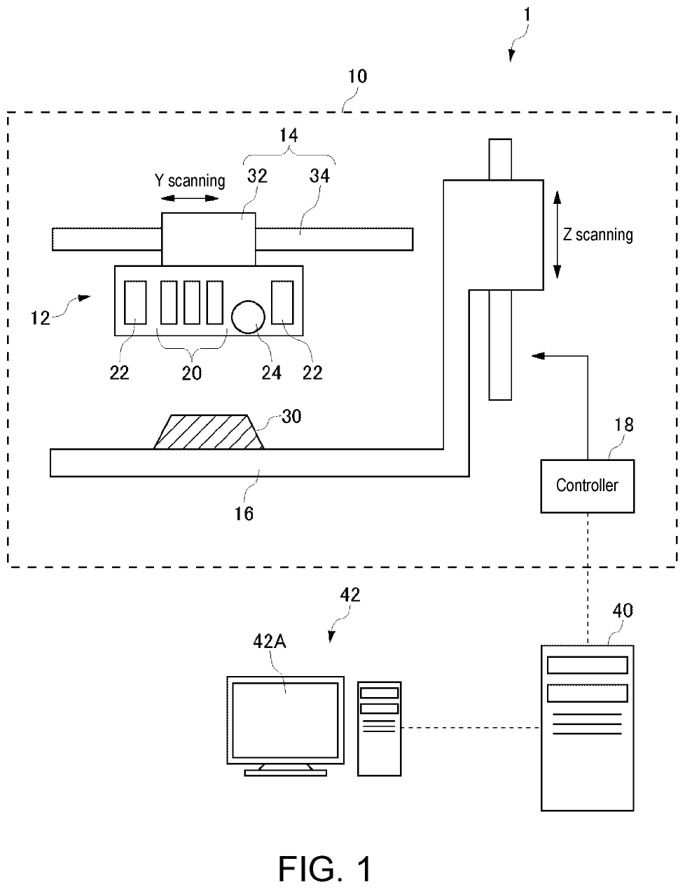

Hereinafter, a first embodiment of the present disclosure will be described. FIG. 1 is a view showing a configuration of a 3D printer system 1. The 3D printer system 1 includes a 3D printer 10, a control PC 40, and a user PC 42.

The 3D printer 10 is a shaping device of an inkjet method that includes an ejection unit 12, a main scan driver 14, a shaping table 16, and a controller 18, and that shapes a shaped object 30 by solidifying an ultraviolet curable resin sprayed from the ejection unit 12 with ultraviolet light and layering the ultraviolet curable resin.

The ejection unit 12 includes an ink head 20 that ejects colored and colorless ink to become the material of the shaped object 30 and ink containing a support material, an ultraviolet light source 22 that cures the ejected ink, and a flattening roller 24 that flattens the layered surface of the curable resin formed during the shaping of the shaped object 30. In the example of FIG. 1, three ink heads 20 are shown, but the number of ink heads 20 can be an appropriate number depending on the number of types of ink to use.

The ejection unit 12 forms each layer configuring the shaped object 30 by, for example, ejecting and curing ink droplets of a curable resin, which cures by irradiation of ultraviolet light. More specifically, the ejection unit 12 repeatedly performs over plural times, for example, a layer forming operation of forming a layer of curable resin by ejecting ink droplets in accordance with an instruction of the controller 18, and a curing operation of curing the layer of curable resin formed in the layer forming operation. The ejection unit 12 thus forms a plurality of layers of cured curable resin in an overlapping manner. The 3D printer 10 is not limited to the one using the ultraviolet curable resin, and may adopt a method of layering a thermoplastic curable resin that is sprayed from the ejection unit 12 in a high temperature state and cooled to room temperature to be cured.

The main scan driver 14 is a driver for causing the ejection unit 12 to perform a main scan. Furthermore, the main scan is, for example, an operation in which the ejection unit 12 ejects ink droplets while moving in a main scanning direction (Y direction in the drawing) set in advance.

The main scan driver 14 includes a carriage 32 and a guide rail 34. The carriage 32 is a holding portion that holds the ejection unit 12 so as to face the shaping table 16. That is, the carriage 32 holds the ejection unit 12 so that the ejecting direction of the ink droplets is in the direction toward the shaping table 16. Furthermore, during the main scan, the carriage 32 is moved along the guide rail 34 while holding the ejection unit 12. The guide rail 34 is a rail-like member that guides the movement of the carriage 32, and moves the carriage 32 in accordance with an instruction of the controller 18 at the time of the main scan.

The movement of the ejection unit 12 at the time of the main scan may be a relative movement with respect to the shaped object 30. For example, the shaped object 30 may be moved by fixing the position of the ejection unit 12 and moving the shaping table 16.

The shaping table 16 is a mounting stand on which to mount the shaped object 30 being shaped. The shaping table 16 has a function of moving the upper surface in the vertical direction (Z direction in FIG. 1), and moves the upper surface with the progress of shaping of the shaped object 30 in accordance with an instruction from the controller 18. A distance (gap) between the surface to be shaped in the shaped object 30 in the middle of shaping and the ejection unit 12 is thus appropriately adjusted. Here, the surface to be shaped in the shaped object 30 is, for example, a surface on which the next layer is formed by the ejection unit 12. The scanning in the Z direction of moving the shaping table 16 up and down with respect to the ejection unit 12 may be carried out by, for example, moving the ejection unit 12 side.

The controller 18 is, for example, a CPU of the 3D printer 10, and controls each part of the 3D printer 10 based on slice data indicating shape information of the shaped object 30 to be shaped, color image information, and the like to control the operation of shaping of the shaped object 30.

The control PC 40 receives three-dimensional data (hereinafter referred to as “3D model data”) indicating the shaped object 30 in a predetermined format from the user PC 42. The 3D model data is data indicating the shape of the shaped object 30, the surface color thereof, and the like and for example, is created based on 3D CAD data, data of the outer appearance in which the shaped object 30 to be manufactured is photographed, and the like. The control PC 40 generates the slice data corresponding to the cross-section of each position of the shaped object 30 based on the 3D model data received from the user PC 42. Then, the control PC 40 transmits slice data corresponding to each position to the 3D printer 10.

The user PC 42 transmits the 3D model data to the control PC 40. Furthermore, the user sets the color and thickness of the interior layer and the like of the shaped object 30 according to the input operation of a user through a setting image displayed on a monitor 42A. Details of this setting will be described later. Although one user PC 42 is shown in FIG. 1, a plurality of user PCs 42 may be provided.

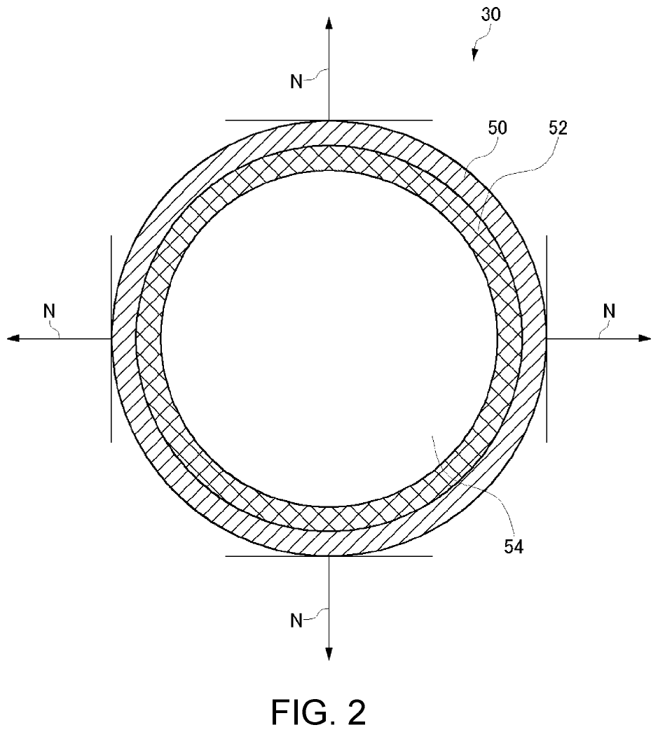

FIG. 2 is a schematic view showing a layered structure of the shaped object 30 of the present embodiment, and schematically shows a cross-sectional structure of the shaped object 30 which is a sphere as an example. As shown in FIG. 2, the shaped object 30 of the present embodiment is configured by a color layer 50 that is colored and forms the surface of the shaped object 30, a reflection layer 52 that forms a lower layer of the color layer 50, and an interior layer 54 that forms a lower layer of the reflection layer 52. The reflection layer 52 and the interior layer 54 are collectively referred to as a shaping layer.

The color layer 50 is a colored layer that reproduces the color specified by the 3D model data, and is visually recognized as the color of the shaped object 30. The thickness of the color layer 50 is, for example, 0.2 mm to 0.4 mm.

The reflection layer 52 has a thickness enough to reflect the color of the color layer 50 to the outside. That is, if the reflection layer 52 is too thin, the color of the interior layer 54 may affect the color of the shaped object 30 visually recognized from the outside. The color of the reflection layer 52 is white by way of an example, but is not limited thereto, and may be other than white according to the color of the color layer 50.

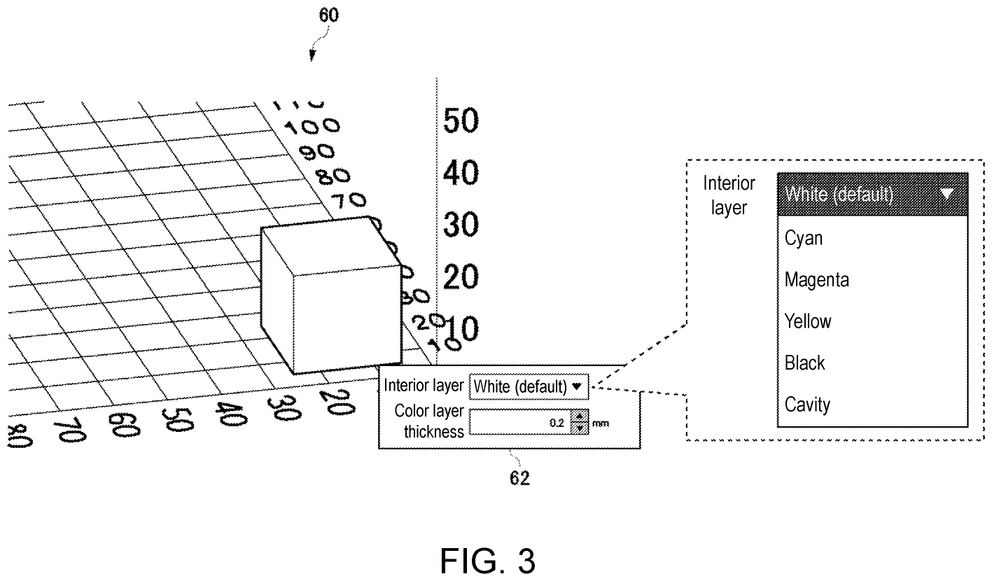

The interior layer 54 is given an arbitrary color or material by the user. The interior layer 54 may be entirely or partially formed with a cavity. FIG. 3 is an example of a setting image of a 3D print displayed on a monitor 42A of a user PC 42, and a selection image 62 for selecting the color of the interior layer 54 is displayed together with a layout image 60 of the shaped object 30 on the monitor 42A. A portion indicated with a broken line in FIG. 3 is an enlarged view showing a display state at the time of selecting the color of the interior layer 54. As shown in FIG. 3, although the default color of the interior layer 54 is white, other colors (cyan, magenta, yellow, black, etc.) and formation of cavity in the interior layer 54 can be selected. In the following description, the color of the interior layer 54 selected by the user is referred to as a specified color.

Furthermore, in the selection image 62 shown in FIG. 3, the user can select the thickness of the color layer 50 (hereinafter referred to as “color layer thickness”) by way of example. For example, when the user desires to adjust the shading of the color of the shaped object 30, the user selects the color layer thickness. More specifically, the user selects the color layer thickness so as to be thick when desiring the color to be dark, and the user selects the color layer thickness so as to be thin when desiring the color to be light.

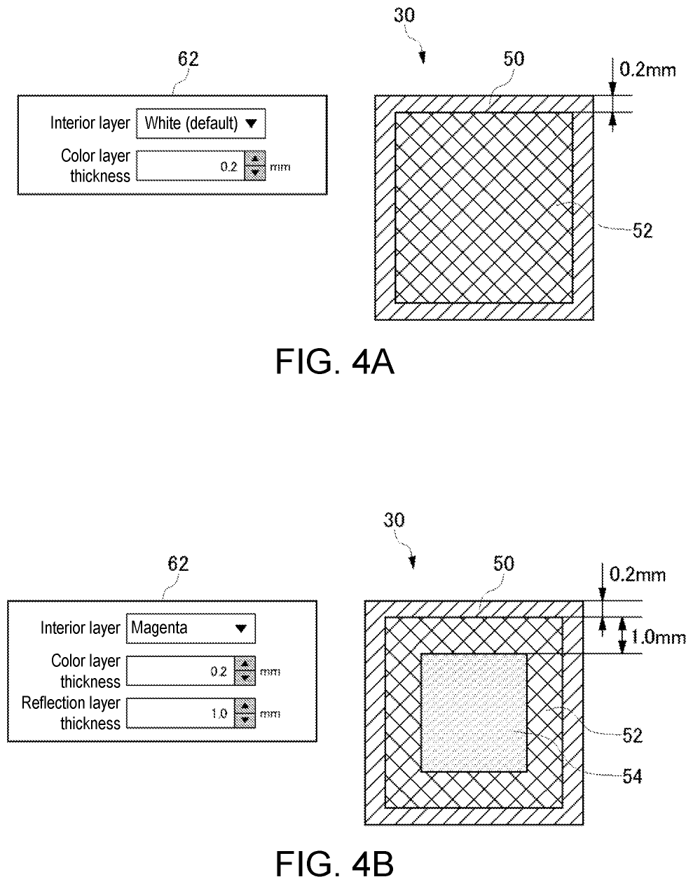

FIGS. 4A and 4B are schematic diagrams showing a cross-section of the shaped object 30 corresponding to the color of the interior layer 54, where FIG. 4A shows a case where the color of the interior layer 54 is white, and FIG. 4B shows a case where the color of the interior layer 54 is a color other than white (magenta by way of an example).

As shown in FIG. 4A, when the color of the interior layer 54 is white, it is not substantially distinguished from the reflection layer 52 that is also white. Thus, when the color of the interior layer 54 and the color of the reflection layer 52 are the same color, the thickness of the reflection layer 52 (hereinafter referred to as “reflection layer thickness”) is not set by the user.

On the other hand, as shown in FIG. 4B, when the interior layer 54 and the reflection layer 52 are different colors, the reflection layer thickness is set. The reflection layer thickness is determined to have a value enough to reflect the color of the color layer 50. By way of example, the reflection layer thickness may be defined in advance according to the color and thickness of the color layer 50, or may be determined according to the color and thickness of the color layer 50 using a predetermined calculation formula.

In the example of FIG. 4B, the user can also select the reflection layer thickness. The user arbitrarily selects the reflection layer thickness, for example, when the reflection layer 52 is formed thin, the interior layer 54 is colored and the coloring of the interior layer 54 is made transparent so as to be visually recognized from the outside, when the reflection layer 52 is formed thin, the interior layer 54 is formed with a cavity to dispose a light source, when the user desires to visually recognize the light of the light source from the outside, and the like.

Here, the thickness of the color layer 50 of the present embodiment is determined with a normal direction N (see FIG. 2) with respect to the outer contour of the shaped object 30 as a reference. Thus, by having the thickness of the color layer 50 in the normal direction constant, the color of the shaped object 30 can be appropriately expressed.

The color layer 50 may be formed on the outer side with respect to the outer contour of the shaped object 30, or may be formed on the inner side with respect to the outer contour of the shaped object 30. For example, when the size of the shaped object 30 is small and the color layer thickness relatively affects the size of the shaped object 30, the color layer 50 is formed on the inner side with respect to the outer contour of the shaped object 30. On the other hand, when it is desired to further increase the strength of the shaped object 30, the color layer 50 is formed on the outer side with respect to the outer contour of the shaped object 30. Thus, in the present embodiment, the color layer 50 can be formed at the position suitable for the shaped object 30.

The thickness of the reflection layer 52 of the present embodiment is determined with the normal direction N with respect to the outer contour of the shaped object 30 as a reference. That is, if the reflection layer thickness varies with respect to the normal direction N of the outer contour of the shaped object 30, the interior layer 54 may affect the color of the shaped object 30 visually recognized from the outside. Therefore, the reflection layer thickness becomes constant with respect to the outer contour of the shaped object 30 by determining the reflection layer thickness based on the normal direction N with respect to the outer contour of the shaped object 30, and hence the interior layer 54 can be prevented from affecting the color of the shaped object 30 visually recognized from the outside.

Similar to FIG. 4B, even when the interior layer 54 is formed with a cavity, the thickness is determined based on the normal direction N with respect to the outer contour of the shaped object 30, and the reflection layer thickness is a thickness enough to reflect the color of the color layer 50.

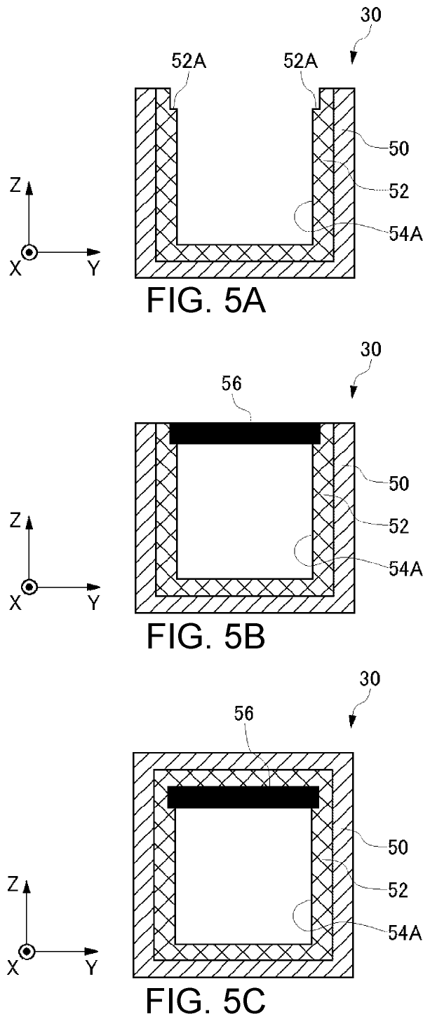

FIGS. 5A to 5C are schematic diagrams showing a shaping method in a case where the interior layer 54 is a cavity 54A, and schematically illustrates a cross-section of the shaped object 30. As shown in FIG. 5A, the 3D printer 10 forms the cavity 54A by layering the color layer 50 and the reflection layer 52 so that the inside of the shaped object 30 becomes hollow having a set size (extracted space).

Thereafter, as illustrated in FIG. 5B, the 3D printer 10 places a lid member 56 on the shaping surface of the shaped object 30. In this case, the shaping surface of the shaped object 30 is the upper surface of the uppermost layer formed at that time point in the shaped object 30. The lid member 56 is sized to cover the upper part of the cavity 54A in the XY plane. As shown in FIG. 5A, a supporting portion 52A, which is a step for supporting the lid member 56, is formed at the upper part of the reflection layer 52.

Then, as shown in FIG. 5C, the 3D printer 10 completes the shaped object 30 by further layering the reflection layer 52 and the color layer 50 at the upper part of the shaped object 30 including the lid member 56.

Note that, a shaping method for the shaped object 30 in which the cavity 54A is formed using such a lid member 56 is described in detail in Japanese Unexamined Patent Publication No. 2017-71154.

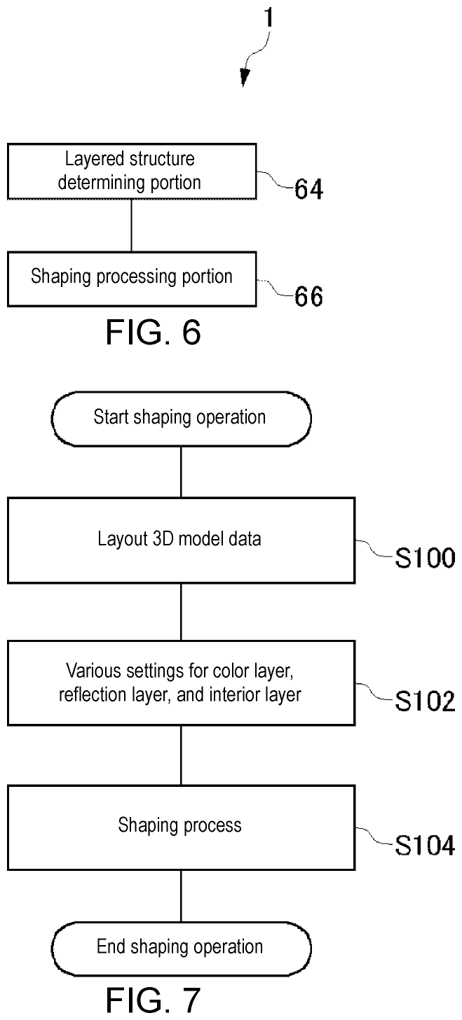

FIG. 6 is a functional block diagram relating to an internal structure changing process of the shaped object according to the present embodiment. The 3D printer system 1 according to the present embodiment includes a layered structure determining portion 64 and a shaping processing portion 66. In the 3D printer system 1 according to the present embodiment, as an example, the user PC 42 has a function of the layered structure determining portion 64, and the control PC 40 has a function of the shaping processing portion 66.

The layered structure determining portion 64 receives the selection of the color and the like of the reflection layer 52 and the interior layer 54 by the user for the shaped object 30 (3D model data), and determines the layered structure of the shaped object 30. The reflection layer thickness is also determined by the layered structure determining portion 64.

The shaping processing portion 66 draws a 3D model indicating the shaped object 30 based on the layered structure and the 3D model data determined by the layered structure determining portion 64, and generates slice data corresponding to the cross-section of each position of the shaped object 30 and transmits the same to the 3D printer 10. The slice data defines which portions are the color layer 50, the reflection layer 52, and the interior layer 54 in each slice, and also defines the color of each portion.

The slice data of the present embodiment is generated as data including thickness data indicating the thicknesses of the color layer 50 and the reflection layer 52 with the normal direction with respect to the outer contour of the shaped object 30 as a reference. The 3D printer thus can shape the shaped object 30 so that the thicknesses of the color layer 50 and the reflection layer 52 are appropriate thicknesses.

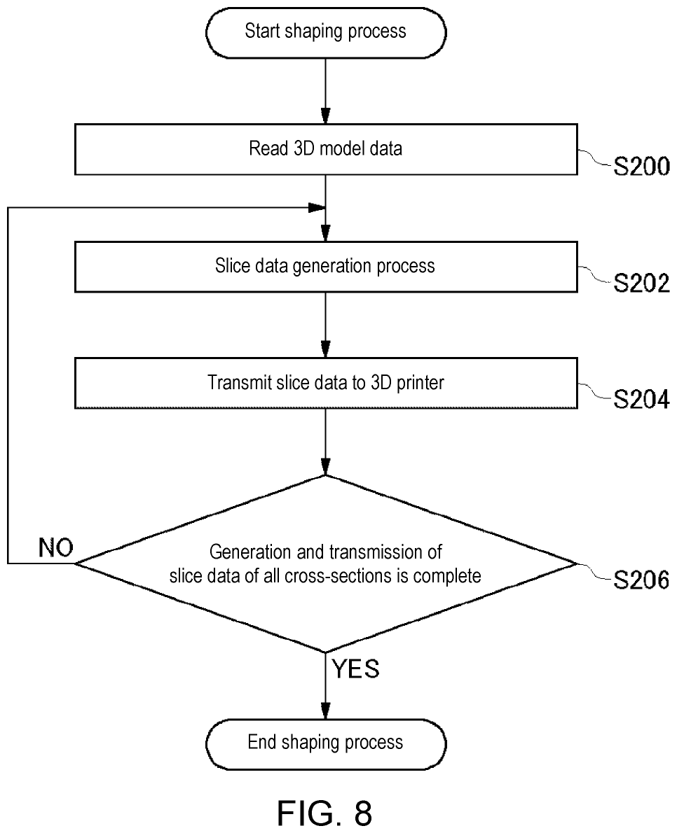

Next, a flow of a specific process of the shaping method of the present embodiment will be described with reference to FIGS. 7 and 8.

FIG. 7 is a flowchart showing the flow of the shaping operation by the user, and is executed when the user causes the 3D printer 10 to shape the shaped object 30. Steps S100 and S102 are executed by the layered structure determining portion 64 described above, and step S104 is executed by the shaping processing portion 66 described above.

First, in step S100, the 3D model data selected by the user is layout displayed on the monitor 42A of the user PC 42. This layout display is, for example, a display as shown in FIG. 3.

In the next step S102, various settings relating to the color layer 50, the reflection layer 52, and the interior layer 54 are performed. More specifically, the thickness of the color layer 50 and the reflection layer 52, the color of the interior layer 54, the setting of the cavity 54A, and the like are performed. Here, the color of the interior layer 54 or the setting of the cavity 54A is selected by the user, and the color layer thickness and the reflection layer thickness are also determined. Then, the user PC 42 transmits the 3D model data in which these settings have been made to the controller 18 of the 3D printer 10.

In the next step S104, the shaping process is executed.

FIG. 8 is a flowchart showing the flow of the shaping process executed in step 104.

In step S200, the control PC 40 reads the 3D model data received from the user PC 42.

In the next step S202, slice data generation process based on the 3D model data is performed.

In the next step S204, the generated slice data is transmitted to the 3D printer.

In the next step S206, whether or not the generation of slice data for all cross-sections in the shaped object 30 indicated by the 3D model data and the transmission to the 3D printer 10 have been completed are determined, where the shaping process is terminated in a case where positive determination is made and the process returns to step S202 in a case where negative determination is made. Note that, the slice data generated by the control PC 40 is transmitted to the controller 18 of the 3D printer 10. Then, the controller 18 controls the ejection unit 12 based on the received slice data to cause the 3D printer 10 to shape the shaped object 30.

### Second Embodiment

Hereinafter, a second embodiment of the present disclosure will be described. In the shaping method of the present embodiment, when the lower layer of the color layer 50 is the cavity 54A, the combined thickness of the color layer 50 and the reflection layer 52 is set to a thickness that can maintain the mechanical strength of the shaped object 30. Accordingly, the amount of material for forming the shaped object 30 can be reduced while maintaining the shape of the shaped object 30 even if the interior of the shaped object 30 is the cavity 54A.

In the present embodiment, the color layer 50 and the reflection layer 52 are collectively referred to as an outer contour layer, and the thickness of the outer contour layer is referred to as an outer contour thickness. In the present embodiment, the outer contour layer thickness is a thickness that maintains the mechanical strength of the shaped object 30, and is defined according to the size of the shaped object 30, the size of the cavity 54A, the weight of the shaped object 30, and the like, and for example, is calculated by a predetermined calculation formula.

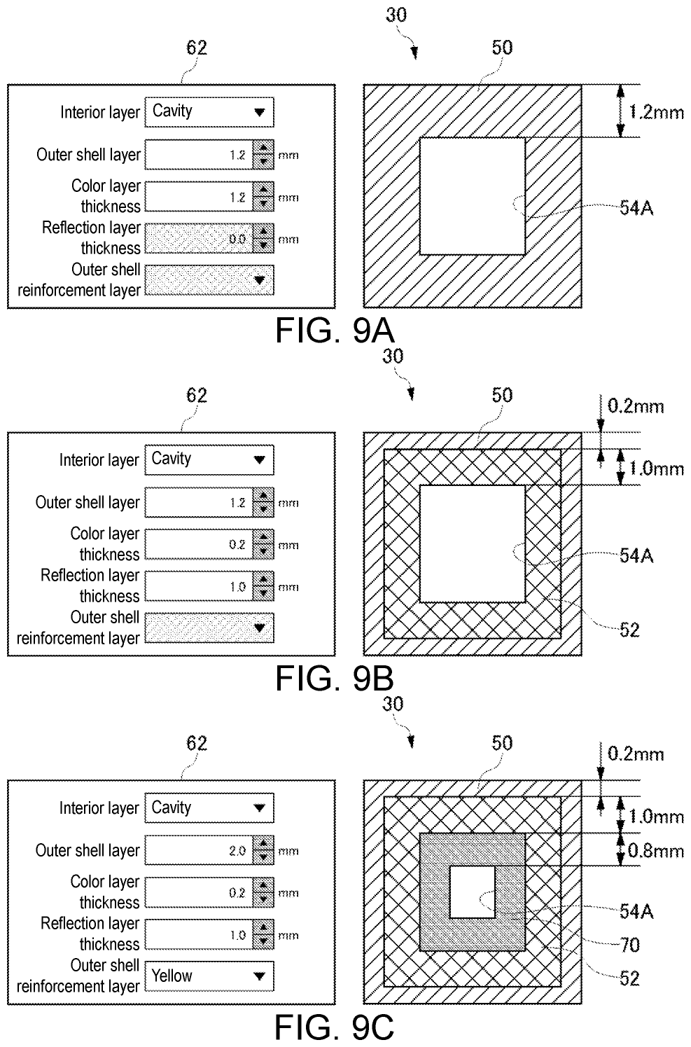

FIGS. 9A to 9C are schematic diagrams related to the setting of the outer contour reinforcement layer 70 when the interior layer 54 is the cavity 54A. Note that, the setting shown in FIGS. 9A to 9C is performed by the user PC 42 as an example.

In FIG. 9A, the outer contour thickness is defined as 1.2 mm, and the color layer thickness is also 1.2 mm. That is, since the color layer thickness is sufficient as a thickness for maintaining the mechanical strength, the reflection layer 52 is not necessary. In the example of FIG. 9A, since the color layer thickness is sufficiently thick, the interior layer 54 formed as the cavity 54A does not affect the color of the shaped object 30 visually recognized from the outside even when the reflection layer thickness is 0 mm.

In FIG. 9B, the outer contour thickness is defined as 1.2 mm, and the color layer thickness is 0.2 mm. Thus, the reflection layer thickness is 1.0 mm so that the outer contour thickness becomes 1.2 mm. Note that, the reflection layer thickness may be selected by the user, and the total value of the color layer thickness and the reflection layer thickness may be thicker than the defined outer contour thickness.

In FIG. 9C, the outer contour thickness is defined as 2.0 mm, the color layer thickness is 0.2 mm, and the reflection layer thickness is 1.0 mm. Thus, the outer contour thickness is not reached with the total value of the color layer thickness and the reflection layer thickness. Therefore, the outer contour reinforcement layer 70 is formed in the lower layer of the reflection layer 52. Thus, in the example of FIG. 9C, the outer contour reinforcement layer 70 is formed between the reflection layer 52 and the cavity 54A, and the combined thickness of the color layer 50, the reflection layer 52, and the outer contour reinforcement layer 70 is the thickness for maintaining the mechanical strength of the shaped object 30. The thickness of the outer contour reinforcement layer 70 (hereinafter referred to as “outer contour reinforcement layer thickness”) is calculated by the control PC 40 as described later.

Furthermore, the color (specified color) of the outer contour reinforcement layer 70 can be selected by the user. That is, since the user can arbitrarily select the specified color, similarly to the outer contour reinforcement layer 70 and the interior layer 54, the material for forming the shaped object 30 can be used effectively.

The thickness and color of each layer set in this way are transmitted from the user PC 42 to the control PC 40 together with the 3D model data.

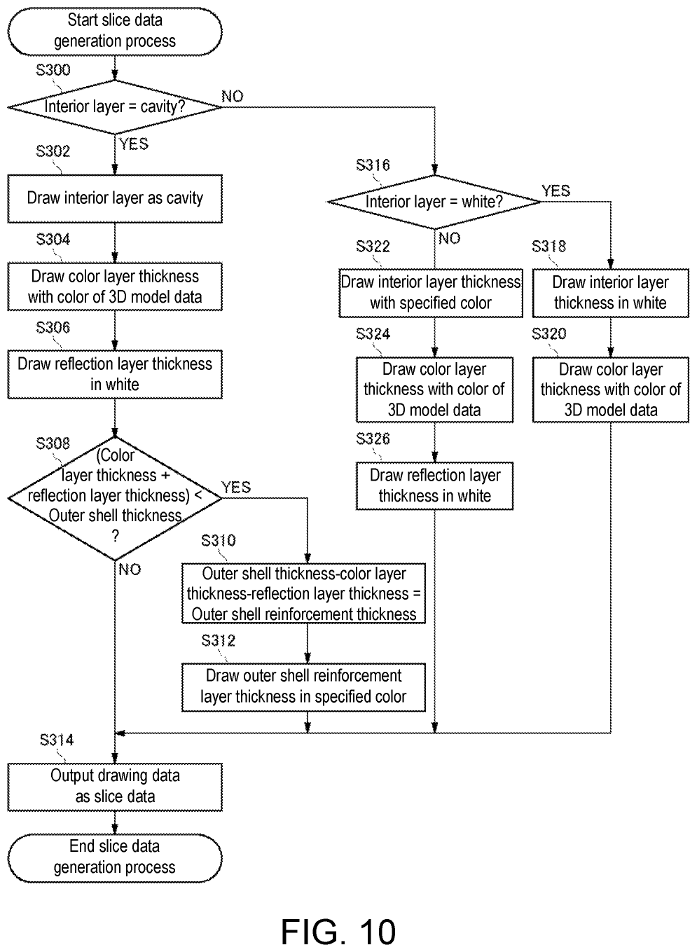

FIG. 10 is a flowchart showing a flow of slice data generation process (correspond to step 202 in FIG. 8) of the present embodiment. The slice data generation process is executed by the shaping processing portion 66 (control PC 40).

First, in step S300, whether or not the interior layer 54 indicated by the 3D model data is the cavity 54A is determined, where the process proceeds to step S302 if positive determination is made and the process proceeds to step S316 if negative determination is made.

In step S302, the interior layer 54 is the cavity 54A, and drawing data indicating the shaped object 30 based on the 3D model data is drawn.

In the next step S304, the color layer thickness is drawn in a color indicated by the 3D model data with respect to the drawing data.

In the next step S306, the reflection layer thickness is drawn in white with respect to the drawing data.

In the next step S308, whether or not the total value of the color layer thickness and the reflection layer thickness is smaller than the defined outer contour thickness is determined, where the process proceeds to step S310 if positive determination is made. On the other hand, when a negative determination is made, that is, when the total value of the color layer thickness and the reflection layer thickness is greater than or equal to the defined value, the process proceeds to step S314.

In step S310, a value obtained by subtracting the total value of the color layer thickness and the reflection layer thickness from the outer contour thickness is calculated as the outer contour reinforcement layer thickness.

In the next step S312, the outer contour reinforcement layer thickness is drawn with the specified color with respect to the drawing data, and the process proceeds to step 314.

In step S314, slice data is generated from the drawing data and output. The output slice data is transmitted to the 3D printer 10.

In step S316, to which the process proceeds when a negative determination is made in step S300, whether or not the interior layer 54 indicated by the 3D model data is white is determined, where the process proceeds to step S318 if positive determination is made, and the process proceeds to step S322 if negative determination is made.

In step S318, the interior layer thickness is drawn in white with respect to the drawing data.

In the next step S320, the color layer thickness is drawn in a color indicated by the 3D model data with respect to the drawing data, and the process proceeds to step S314.

In step S322, the interior layer thickness is drawn in a specified color with respect to the drawing data.

In the next step S324, the color layer thickness is drawn in a color indicated by the 3D model data with respect to the drawing data.

In the next step S326, the reflection layer thickness is drawn in white with respect to the drawing data, and the process proceeds to step S314.

### Third Embodiment

Hereinafter, a third embodiment of the present disclosure will be described. In the present embodiment, the thickness of the reflection layer 52 is determined in accordance with a built-in element built in the lower layer of the reflection layer 52. The shaped object 30 utilizing the action of the built-in element thus can be formed.

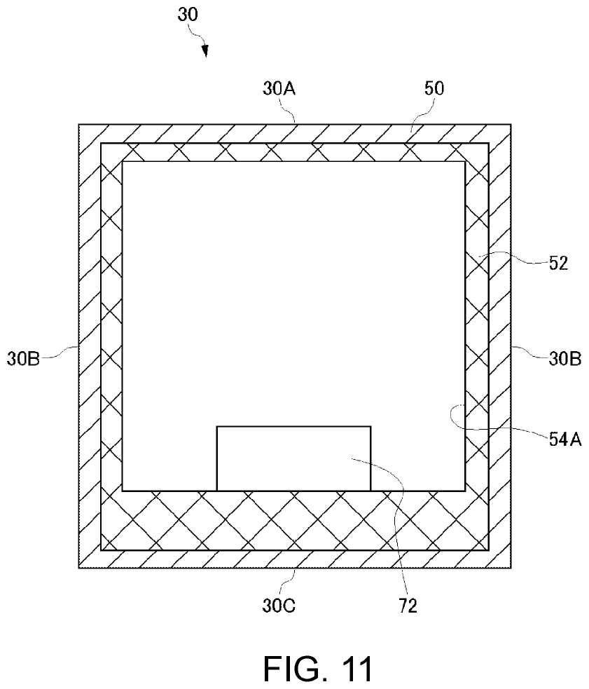

FIG. 11 is a schematic view showing a cross-section of a shaped object 30 incorporating a light emitting body 72 as an example of a built-in element. The light emitting body 72 is, for example, an LED (Light Emitting Diode) device or an object having a light accumulating function. In the shaped object 30, the interior layer 54 is formed as a cavity 54A in order to place the light emitting body 72 inside. Thus, when the light emitting body 72 is the built-in element, it is desirable that the light emission from the light emitting body 72 can be visually recognized from the outside of the shaped object 30.

Therefore, in the example of FIG. 11, the reflection layer thickness on the upper surface 30A and the side surface 30B of the shaped object 30 is set to a thickness that allows the light from the light emitting body 72 to pass therethrough. On the other hand, the reflection layer thickness on the lower surface 30C of the shaped object 30 is set to a thickness that can maintain the mechanical strength so that the shaped object 30 is not damaged even if the light emitting body 72 is placed in the cavity 54A. Note that, the reflection layer thickness is determined by the layered structure determining portion 64 based on the size and weight of the built-in element input by the user and the action thereof.

Furthermore, the built-in element is not limited to the light emitting body 72, and may be a heavy object that becomes a weight for lowering the center of gravity of the shaped object 30. In this case, the reflection layer thickness on the upper surface 30A and the side surface 30B of the shaped object 30 is set to a thickness that prevents the cavity 54A from affecting the color of the shaped object 30 visually recognized from the outside. On the other hand, the reflection layer thickness on the lower surface 30C of the shaped object 30 is set to a thickness that can maintain the mechanical strength that does not damage the shaped object 30 even if a heavy object is placed in the cavity 54A.

### Effects of the Embodiment

(1) The shaping method of the present embodiment is a shaping method for the shaped object 30 configured to include at least the color layer 50 that is colored and that forms the surface of the shaped object 30, and the reflection layer 52 that forms the lower layer of the color layer 50, and determines the thickness of the reflection layer 52 based on a normal direction with respect to the outer contour of the shaped object 30. According to the present configuration, in order to reflect the color of the color layer 50, the thickness of the reflection layer 52 is set to a sufficient thickness having the normal direction N with respect to the outer contour of the shaped object 30 as a reference. Thus, even if the interior layer 54 formed under the reflection layer 52 is formed of an arbitrary color or material, the interior layer 54 can be prevented from affecting the color of the shaped object 30 visually recognized from the outside.

In the shaping method of the present embodiment, when the lower layer of the color layer 50 is a cavity, the combined thickness of the color layer 50 and the reflection layer 52 may be set to a thickness that can maintain the mechanical strength of the shaped object 30. According to the present configuration, the amount of material for forming the shaped object 30 can be reduced while maintaining the shape of the shaped object 30.

In the shaping method of the present embodiment, when the lower layer of the color layer 50 is a cavity, a reinforcement layer is formed between the reflection layer 52 and the cavity, and the combined thickness of the color layer 50, the reflection layer 52, and the outer contour reinforcement layer 70 may be set to a thickness that can maintain the mechanical strength of the shaped object 30. According to the present configuration, the amount of material for forming the shaped object 30 can be reduced while maintaining the shape of the shaped object 30.

In the shaping method of the present embodiment, the color of the outer contour reinforcement layer 70 may be specified. According to the present configuration, the material for forming the shaped object 30 can be used effectively.

In the shaping method of the present embodiment, the thickness of the reflection layer 52 may be determined according to the built-in element built in the lower layer of the reflection layer 52. For example, when the light emitting body is the built-in element, it is desirable that the light emission from the light emitting body can be visually recognized from the outside of the shaped object 30. According to the present configuration, the shaped object 30 utilizing the action of the built-in element can be formed.

The shaping method of the present embodiment may generate thickness data indicating the thicknesses of the color layer 50 and the reflection layer 52 with the normal direction with respect to the outer contour of the shaped object 30 as a reference. According to the present configuration, the thicknesses of the color layer 50 and the reflection layer 52 can be made appropriate.

In the shaping method of the present embodiment, the color layer 50 may be formed on the outer side with the outer contour of the shaped object 30 as a reference. According to the present configuration, the color layer 50 can be formed at a position suitable for the shaped object 30.

In the shaping method of the present embodiment, the color layer 50 may be formed on the inner side with the outer contour of the shaped object 30 as a reference. According to the present configuration, the color layer 50 can be formed at a position suitable for the shaped object 30.

The shaping device of the present embodiment is a shaping device for the shaped object 30 configured to include at least the color layer 50 that is colored and that forms the surface of the shaped object 30, and the reflection layer 52 that forms the lower layer of the color layer 50, and layers the reflection layer 52 having a thickness determined based on a normal direction with respect to the outer contour of the shaped object 30 on the lower layer of the color layer 50. According to the present configuration, the interior layer 54 can be prevented from affecting the color of the shaped object 30 visually recognized from the outside.

### INDUSTRIAL APPLICABILITY

The present disclosure relates to a shaping method for shaping a shaped object through a layered shaping method.

What is claimed is:

1. A shaping method, comprising:
forming a shaped object, being configured to include at least a colored layer that is colored and that forms a surface of the shaped object, and a reflection layer that forms a lower layer of the colored layer,
wherein
a thickness of the reflection layer is determined with a normal direction with respect to an outer contour of the shaped object as a reference.

2. The shaping method according to claim 1, wherein
when the lower layer of the colored layer is a cavity, a combined thickness of the colored layer and the reflection layer is a thickness for maintaining a mechanical strength of the shaped object.

3. The shaping method according to claim 1, wherein
when the lower layer of the colored layer is a cavity, a reinforcement layer is formed between the reflection layer and the cavity, and
a combined thickness of the colored layer, the reflection layer, and the reinforcement layer is a thickness for maintaining a mechanical strength of the shaped object.

4. The shaping method according to claim 3, wherein
a color of the reinforcement layer is capable of being specified.

5. The shaping method according to claim 1, wherein
the thickness of the reflection layer is determined according to a built-in element built in the lower layer of the reflection layer.

6. The shaping method according to claim 1, wherein
a thickness data indicating the thicknesses of the colored layer and the reflection layer with the normal direction with respect to the outer contour of the shaped object as a reference is generated.

7. The shaping method according to claim 1, wherein
the colored layer is formed on an outer side with the outer contour of the shaped object as a reference.

8. The shaping method according to claim 1, wherein
the colored layer is formed on an inner side with the outer contour of the shaped object as a reference.

9. A shaping device for a shaped object configured to include at least a colored layer that is colored and that forms a surface of the shaped object and a reflection layer that forms a lower layer of the colored layer, wherein
the reflection layer having a thickness determined based on a normal direction with respect to an outer contour of the shaped object is layered on the lower layer of the colored layer.

10. The shaping method according to claim 2, wherein
the thickness of the reflection layer is determined according to a built-in element built in the lower layer of the reflection layer.

11. The shaping method according to claim 3, wherein
the thickness of the reflection layer is determined according to a built-in element built in the lower layer of the reflection layer.

12. The shaping method according to claim 4, wherein
the thickness of the reflection layer is determined according to a built-in element built in the lower layer of the reflection layer.

13. The shaping method according to claim 2, wherein
a thickness data indicating the thicknesses of the colored layer and the reflection layer with the normal direction with respect to the outer contour of the shaped object as a reference is generated.

14. The shaping method according to claim 3, wherein
a thickness data indicating the thicknesses of the colored layer and the reflection layer with the normal direction with respect to the outer contour of the shaped object as a reference is generated.

15. The shaping method according to claim 4, wherein
a thickness data indicating the thicknesses of the colored layer and the reflection layer with the normal direction with respect to the outer contour of the shaped object as a reference is generated.

16. The shaping method according to claim 5, wherein
a thickness data indicating the thicknesses of the colored layer and the reflection layer with the normal direction with respect to the outer contour of the shaped object as a reference is generated.
